(19) United States
(12) Patent Application Publication
(10) Pub. No.: US 2022/0264299 A1
(43) Pub. Date: Aug. 18, 2022

(54) VIRTUAL ENTERPRISE SECURE NETWORKING

(71) Applicant: Intel Corporation, Santa Clara, CA (US)

(72) Inventors: Omer BEN-SHALOM, Rishon Le-Tzion (IL); Alex NAYSHTUT, Gan Yavne (IL); David BIRNBAUM, Modiin (IL); Ehud RESHEF, Qiryat Tivon (IL)

(21) Appl. No.: 17/740,136

(22) Filed: May 9, 2022

(51) Int. Cl. H04W 12/065

(52) U.S. Cl. CPC H04W 12/065

(57) ABSTRACT

Methods and apparatus for virtual enterprise secure networking. A Layer 2 (L2)-based secured network solution is provided using resources of a computer platform to connect an operating system to a secured backend overlay network (e.g., enterprise, service provider or ‘zero trust network service’) in a way that does not require changes in the operating system and connection manager or alteration of network infrastructure (e.g., wireless access point) in the location where a client may reside. Under an aspect of the solution, the computer platform itself (e.g., platform hardware/Firmware/drivers) provides part of the role of the authenticator in an Institute of Electrical and Electronics Engineers (IEEE) 802.1X scheme either directly by simulation of an Access Point (AP) or as a pass through to the overlay network core. This replaces the traditional access point/switch authenticator role.

### BACKGROUND INFORMATION

In today's world, especially post COVID, a major part of compute work is done remotely. While a lot of work has moved to cloud-based services and security, many of the resources that are used still reside on premise and/or use legacy protocols. While secure access to such resources is easy while working on premise (such as an in-person company work location), guaranteeing access and security while working remotely is more challenging. Usually, this requires creating a secured remote connection (such as a Virtual Private Network (VPN)) from a device to a trusted network environment, placing the device (in effect) on the ‘internal’ network. Generally, a VPN will use an encrypted tunneling protocol to tunnel traffic from end-to-end (e.g., between two end users, between a user and a Website or Web portal, or between an end user outside an enterprise or other private network to servers and computers inside the enterprise/private network). The encryption is often implemented at the Network Layer (Layer 3 (aka L3) in the OSI (Open Systems Interconnection) model) but sometimes carries network layer packets over an application layer (Layer 7 (aka L7)) in the OSI model) tunnel commonly as ‘SSL VPN’. Both approaches for most end-user equipment, such as laptops, notebooks, and desktop computers, requires use of software-based VPN agents and the like. Unfortunately, the use of a VPN requires administrative control for installing VPN agents, creates complexity in the network setup and significantly impacts network and system performance.

A second approach for providing secure access uses browser-based (aka ‘agentless’) application-level access. This operates in Layer 7 in the OSI model and is implemented using browser plugins or alternative browsers to create the secured tunnel. Browser-based solutions only protect Web applications (e.g., Web services), leaving the rest of the operating system traffic unprotected and cannot be used for non-web protocols like Virtual Network Computing (VNC) and others.

Another third approach uses home or office specialized customer presence equipment (CPE) such as a wired or wireless Access Point (AP) providing Wi-Fi or Ethernet connectivity and creating a remote secured tunnel on the CPE through use of Layer 2 access using specialized external hardware. This requires the end user or an employer to purchase the specialized CPE and is only available in specific locations (e.g., home or office) unless physically carried around. It also may not support some manages networks operated by private companies (e.g., Intel® and Google®) so a multiplicity of such devices may be required.

Much of today's remote compute work employs access to Web services and the like, which are widely deployed by many enterprises for both internal and external use. For its early history, the Internet employed the Hypertext Transfer Protocol (HTTP) to handle most traffic, such as between clients and Web servers (while are also known in the art as HTTP servers). HTTP is an application layer (Layer 7 in the OSI model) protocol that uses plain text. Due to security concerns and other benefits, much if not most of today's Web traffic employs Hypertext Transfer Protocol Secure (HTTPS), which is an extension of HTTP that is used for secure communication over computer networks, such as the Internet. In HTTPS, the communication protocol is encrypted using Transport Layer Security (TLS) or, formerly, Secure Sockets Layer (SSL). The protocol is therefore also referred to as HTTP over TLS, or HTTP over SSL.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an exemplary system architecture under which the solution may be implemented under one embodiment;

FIG. 1a is a schematic diagram illustrating the system architecture of FIG. 1 after session keys have been shared with the edge servers;

FIG. 2 is a schematic diagram illustrating an augmented IEEE 802.1X architecture under which the functionality of the Authenticator is split between an authenticator proxy implemented on a computer platform and a cloud authenticator implemented in a secure cloud environment, according to one embodiment;

FIG. 3 is a message flow diagram illustrating exchanges of messages performed to initialize or pre-configure the solution components;

FIG. 4 is a message flow diagram illustrating an augmented IEEE 802.1X message flow for establish encrypted L2 end-to-end connection between a computer platform and one or more servers in the secure cloud environment;

FIG. 5a is a schematic diagram illustrating a first computer platform architecture that may be implemented by the computer platforms herein where the authenticator proxy functionality is implemented via execution of instructions on a microcontroller, according to one embodiment;

FIG. 5b is a schematic diagram illustrating a second computer platform architecture under which the authenticator proxy functionality is implemented using embedded logic in a wireless card or module, according to one embodiment;

FIG. 5c is a schematic diagram illustrating a third computer platform architecture where the authenticator proxy functionality is implemented via execution of instructions on a microcontroller or processor core integrated on a processor SoC, according to one embodiment; and

FIG. 6 is a diagram of an exemplary IPU card, according to one embodiment.

### DETAILED DESCRIPTION

Embodiments of methods and apparatus for virtual enterprise secure networking are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

Under the embodiments described and illustrated herein, a Layer 2 (L2)-based secured network solution is provided using resources of the computer platform to connect the operating system to a secured backend overlay network (e.g., enterprise, service provider or ‘zero trust network service’) in a way that does not require changes in the operating system and connection manager or alteration of network infrastructure (e.g., wireless access point) in the location where the client may reside. Under an aspect of the solution, the computer platform itself (e.g., platform hardware/Firmware/drivers) provides part of the role of the authenticator in the Institute of Electrical and Electronics Engineers (IEEE) 802.1X scheme directly by simulation of an Access Point (AP) or an access switch while the cloud authenticator is implementing the rest of the authenticator functionality. This replaces the traditional access point/switch authenticator role. The operating system (called the “supplicant”) and the backend authentication server (AS) are connected through the platform service and the cloud authenticator without any dependency on infrastructure or changes to either. This novel approach provides significant benefits compared to both VPN and “remote access point” solutions by the likes of companies such as Cisco® and Aruba®.

In one embodiment, the platform solution exposes to the operating system a virtual network e.g., ‘virtual wireless network BSSID (Basic Service Set Identifier)’ that is indistinguishable from ‘Real’ networks existing in the area, allowing the connection manager/OS to connect to the remote network as if it was actually provisioned in the local environment. Once connected, an augmented IEEE 802.1X authentication process is conducted resulting in end-to-end L2 encryption from the platform to a cloud backend such as enterprise edge, service provider (e.g., Verizon®) or zero trust network provider (e.g., Palo Alto Networks® ‘Prisma Access’, Zscaler, or VMware® SASE (Secure Access Service Edge)). In this fashion, enterprise grade network security such as enterprise level wireless security (WPA2-Enterprise/WPA3-Enterprise) is used over a consumer grade network connection such as a hotel, airport or home environment that may be using Ethernet, 5G, open Wi-Fi, WEP or standard WPA security Wi-Fi, etc., which are all known to be weak/easily broken. This also removes man in the middle (MITM) risks like ‘Evil twin’ or hostile wireless infrastructure due to the end-to-end L2 encryption created between the computer platform and ultimate backend.

In some embodiments, this model can be combined with hotspot 2.0/OpenRoaming to automate the connection to the ‘access wireless’ or ‘underlay’ over which the WPA3-enterprise secured ‘overlay’ network is created.

Under some use cases, an embodiment of the solution creates a virtual network capability on an endpoint such as a user's laptop, notebook, or desktop computer running a Microsoft® Windows® OS, Apple® OS, Linux-base OS, etc. that is managed by a third-party entity, through platform services. This network, in some implementations, will be similar to the enterprise network (e.g., enterprise WLAN SSID, Ethernet with 802.1X etc.).

Platform Layer Network Connection Establishment

To establish the platform layer network connection, the platform layer in the endpoint first connects to an available ‘underlay’ network, such as an Ethernet network (e.g., Local Area Network or LAN), a Wi-Fi network (aka Wireless Local Area Network or WLAN), or a Wireless Wide Area Network (WWAN). This can be done in multiple ways. A first way is to use conventional operating system APIs (Application Program Interfaces) and flows. A second way employs the platform itself using either credentials provisioned to it (e.g., using Wireless Broadband Alliance (WBA) OpenRoaming™), by synchronizing secrets from the OS (as done today in Intel® Active Management Technology (AMT)) or using a “below the OS layer” enablement based on execution of firmware on a microcontroller or other embedded logic or using a Virtual Machine (VM) which owns the platform's network interface hardware (e.g., Network Interface Controller (NIC) or wireless network interface). Under one embodiment, a mechanism is added to configure that entity with credentials, where needed.

Once connected to the local connection and Internet Service Provider (ISP) the platform will perform the following operations to make available a virtual ‘overlay’ network. First, flows will be defined to share the credentials with the platform layer such that in the future it will be able to connect autonomously to the underlay layer. A mechanism may be added to configure that entity with credentials where needed. A secure link will also be established with the overlay network provider (e.g., enterprise core, SASE) below the OS level. This may be implemented on microcontroller, VM, NIC, etc.

Upon connection to the backend ‘cloud controller’, which holds the roles of a cloud authenticator and authentication server, the platform is ready to provide the ‘overlay’ network. The platform then exposes a secured, virtual enterprise network to the operating system abstracting or augmenting that ‘underlay’ transport. This can be in the form of a reported BSSID that does not actually exist and exposes a known enterprise SSID the client is pre-configured or can be configured by the user to use.

Successful implementation of these operations could and likely will result in the OS disconnecting from an existing “local” connection if such was created (using the conventional OS API and flows mentioned above and prioritization by the connection manager) and connecting to the overlay network profile (which may be defined with higher priority). Logic in the platform be configured to maintain the underlay network connectivity to support continuous connectivity to the backend.

Under novel aspects of the solution, the platform acts as part of an IEEE 802.1X “Authenticator” in that it supports the 802.1X discovery and acts as a proxy for the backend cloud authenticator. Unlike a normal AP, this 802.1X ‘authenticator proxy’ tunnels the Extensible Authentication Protocol (EAP) exchange of the authenticator role to the cloud backend, operating as a pass-through. At the same time, the authenticator proxy does not validate the client credentials from the OS nor hold the resulting encryption keys created during the exchange which are used to establish full end-to-end L2 encryption between the platform and cloud backend.

Following the foregoing operations, the platform network interface receives encrypted L2 frames from the OS (or, optionally the L2 encryption may be performed in the network interface itself) and tunnels them to the cloud backend where they are decrypted. As an option, Ethernet frames employing L2 encryption may be wrapped with another layer of encryption, such as but not limited to TLS. Data received from the cloud backend is likewise utilizing L2 encryption, with the platform (OS or network interface) configured to decrypt L2 encrypted frames.

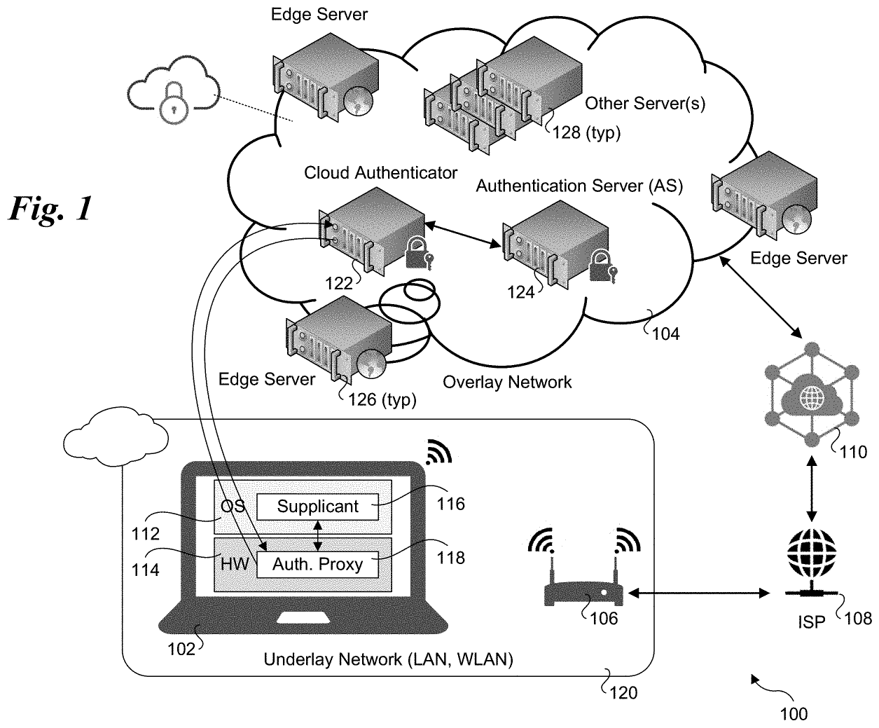

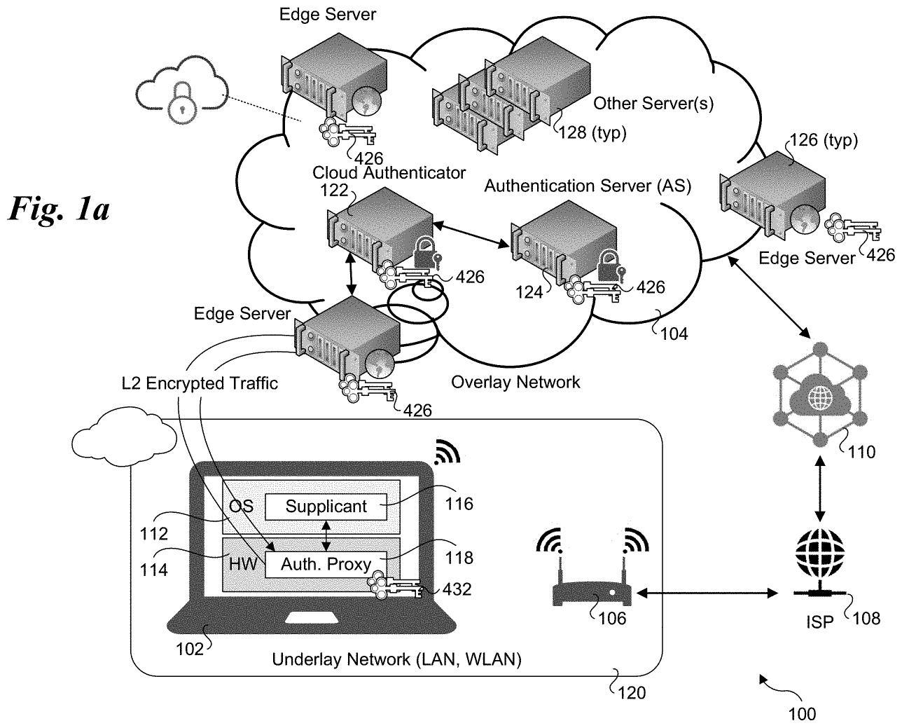

FIG. 1 shows an exemplary system architecture 100 under which the solution may be implemented under one embodiment. The architecture components include a computer platform 102 that is coupled to a secure cloud environment 104 via applicable network facilities, which in this example include a wireless AP 106, an ISP network 108, and an Internet subnet 110 which comprises a portion of the Internet.

Computer platform 102, which is representative of various types of computer platforms and systems such as but not limited to laptops, notebooks, and desktop computers, includes an operating system 112 and hardware 114. In the illustrated embodiment, the OS 112 is an IEEE 802.1X supplicant 116. An IEEE 802.1X authenticator proxy 118 is implemented in hardware 114, as described and illustrated below.

Wireless AP 106 is used to provide communication to local computer platforms and devices in a LAN or WLAN comprising an underlay network 120. Meanwhile, secure cloud environment 104 comprises an overlay network.

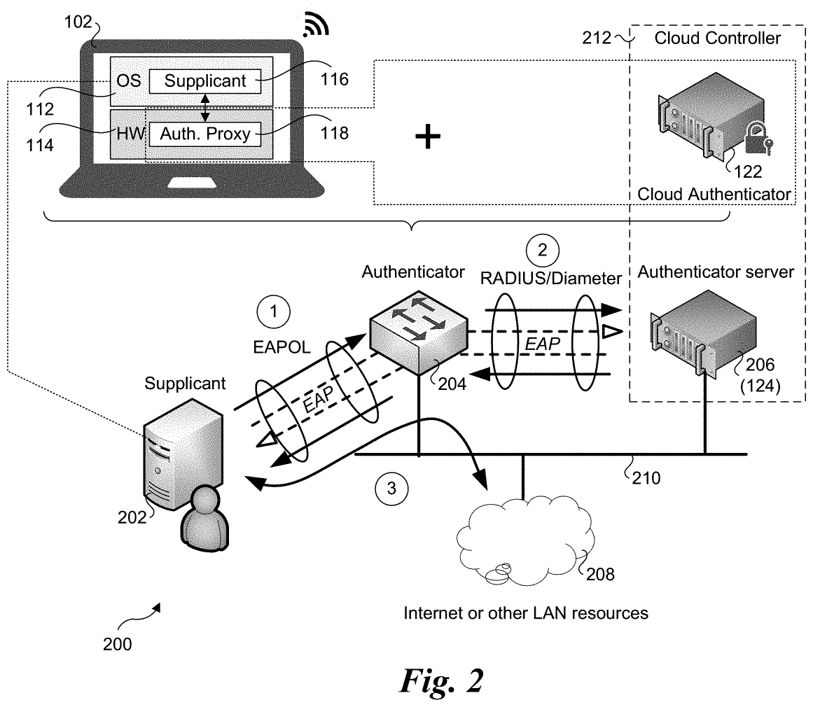

A cloud authenticator 122 and a (cloud) authentication server 124 are implemented in secure cloud environment 104, which may also include one or more edge servers 126 and one or more other servers 128 as well as storage facilities, databases, data stores, and the like (not shown). As further illustrated in FIG. 2, authentication server 124 is an IEEE 802.1X Authentication Server. Generally, authentication server 124 may support other types of authentication server functions and operations in addition to employing an IEEE 802.1X Authentication Server role.

Generally, secure cloud environment 104 may comprise various forms of network-based environments such as a secure enterprise network or zero trust network. The secure cloud environment may employ an SASE architecture or provide other security measures at the cloud edge. The use of ‘cloud’ herein is used to convey these components are deployed in a network (or networks) remote from a user's (supplicant's) local network. While many secure cloud environments are deployed in cloud provider, co-location or privately owned data centers and server farms and the like, the use of ‘cloud’ here is not limited to data centers and server farms. For example, a secure cloud environment may comprise an enterprise network that is deployed on premise, such in a company building or other private or dedicated facility.

Under some embodiments, access to secure cloud environment 104 is facilitated through the use of edge servers 126, which are depicted as Web (HTTP/HTTPS) servers but may also support other protocols. Generally, cloud authenticator 122 may be implemented at the cloud edge (under which computer platform 102 is enabled to directly communicate with it) or may be implemented in the cloud core, in which cases communications between computer platform 102 and cloud authenticator 122 are forwarded via an edge server 126.

FIG. 2 shows a diagram 200 illustrating an augmented IEEE 802.1X architecture, wherein the components in the lower part of diagram 200 depicted a standard IEEE 802.1X architecture. These standard components include a supplicant 202, an authenticator 204, and an authentication server 206. (In FIG. 1, authentication server 124 serves the role of authentication server 206). Generally, supplicant 202 may be one of various types of computer platforms or systems such as laptops, notebooks, desktop computers, workstations, etc. Authenticator 204 serves the IEEE 802.1X Authenticator role and generally may be an Ethernet switch or router, in a LAN or WAN (Wide Area Network), a wireless AP in a WLAN or WWAN. Authenticator 204 differs from a regular consumer grade Ethernet switch/router or wireless AP in that is includes facilities for implementing the IEEE 802.1X Authenticator role. For example, most Ethernet switch/routers and wireless APs used in homes and small companies are not configured to operate as an IEEE 802.1X Authenticator. Similarly, many if not most public wireless APs, such as at schools, coffee shops, airports, libraries, etc., are also not configured to operate as an IEEE 802.1X Authenticator.

Generally, authentication server 206 may be implemented using various types of servers and/or computer platforms/systems that are configured to server the IEEE 802.1X Authentication Server role/function. Usually, the IEEE 802.1X Authentication Server functionality will be implemented by software running on the server/computer platform hardware (e.g., Central Processing Unit (CPU) core(s)).

The standard IEEE 802.1X process proceeds as follows. Prior to the process client-side certificates may be issued to supplicants using Public Key Infrastructure (PKI), while public root certificates may be provisioned to validate server-side certificates to supplicants out-of-band. Otherwise, certificates may be provisioned using other means,

To begin the process, the supplicant establishes a connection with the authenticator. For example, if the authenticator is a Wi-Fi AP, the supplicant will establish a Wi-Fi connection with the AP. This may involve use of client certificates, SIM cards, a password or the like, depending on the type of extensible authentication protocol (EAP) implemented by the Wi-Fi AP. This enables the supplicant to establish a secure connection for exchanging data with the authenticator.

At the point, EAP frames or messages may be communicated between the supplicant and the authenticator using EAPOL (Extensible Authentication Protocol over LAN), which begins with an EAPOL start. This may include an EAP identity request sent from the authenticator to the supplicant and an EAP identity response returned by the supplicant used to confirm the identity of the supplicant.

The Remote Authentication Dial-In User Service (RADIUS) protocol (usually) or Diameter protocol (optionally) is used for communication between the authenticator and the authentication server. Both RADIUS and Diameter protocols provide authentication, authorization, and accounting (AAA) messaging services for network access and data mobility applications. The RADIUS authentication and authorization are defined in RFC 2865 while accounting is described by RFC 2866. The Diameter protocol evolved from the RADIUS protocol and is defined in RFC 6733 and 7075. RADIUS and Diameter employ EAP messages when used for IEEE 802.1X authentication.

As shown in the upper portion of FIG. 2, under embodiments here the Authenticator role/function is split between authenticator proxy 118 and cloud authenticator 122. Meanwhile, supplicant 202 in the standard IEEE 802.1X architecture is implemented by supplicant 116 which is implemented in OS 112 on computer platform 102.

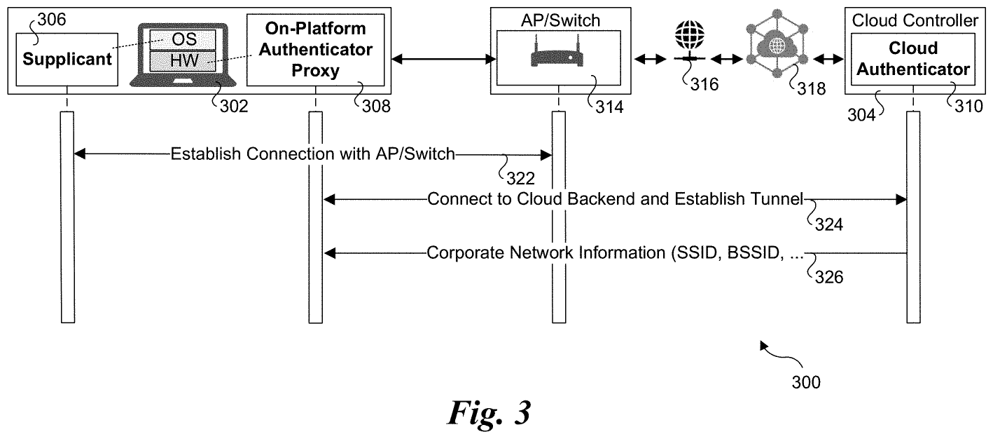

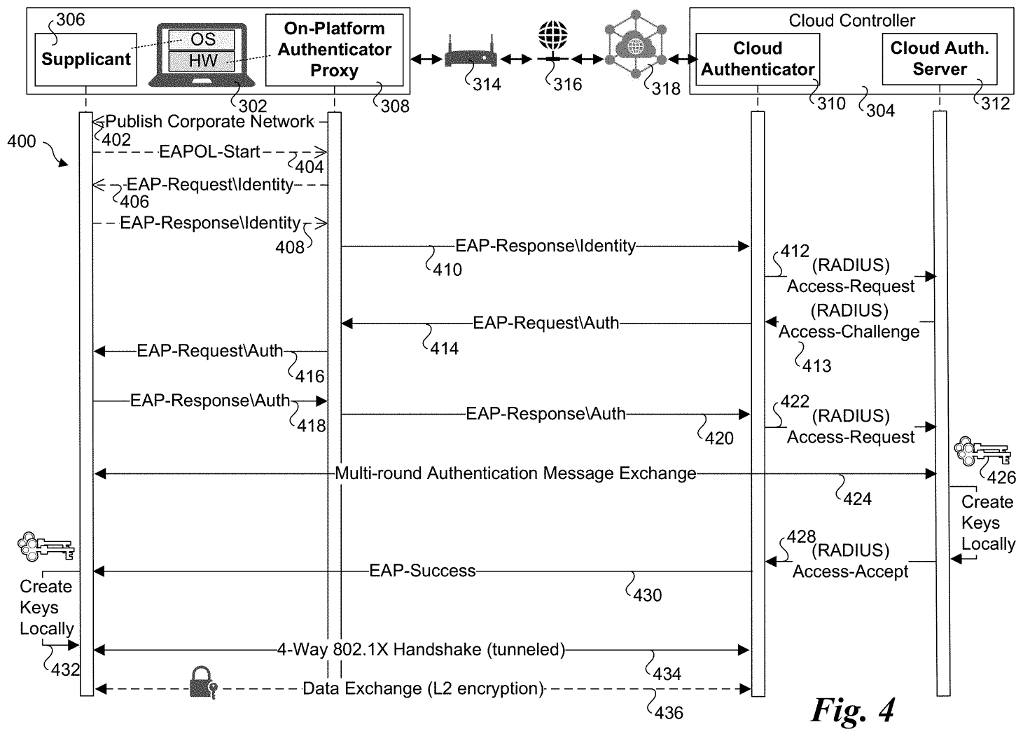

FIGS. 3 and 4 show message flow diagrams 300 and 400 used to establish and L2 end-to-end tunnel and provision keys to be used by an operating system in a computer platform 302 and one or more servers in a secure cloud environment including a cloud controller 304. In FIG. 3, the initial connection is between a supplicant 306 and an AP/switch 314. Subsequently, a connection is established between on-platform authentication proxy 308 and a cloud backend, as depicted by a cloud authenticator 310, which is part of cloud controller 304. Optionally, at this stage the communication with the cloud backend may be with another server that can provide the corporate network information. In FIG. 4, the communication paths further include an on-platform authenticator proxy 308 and a cloud authentication server 312 that is also part of cloud controller 304. The physical communication path further includes an ISP network 316 and an Internet subnet 318.

Message flow diagram 300 illustrates an exchange of frames and messages performed during an initialization or pre-configuration phase. Depending on the use case, these operations may generally be performed once or more times for a given local environment. For example, for a home environment they might be performed once and thereafter may be performed periodically or occasionally to ensure the latest network information is available.

The initialization/pre-configuration flow begins with supplicant 306 (e.g., the OS on compute platform 302) establishing a wired or wireless connection with AP/switch 314, as depicted by a message exchange 322. Optionally, platform 302 may connect to AP/switch 314 using a separate software component or firmware such as but not limited to Intel® Active Management Technology (not shown). Such message exchanges employ conventional known operations that may vary depending on the particular security provisions used and whether a wired or wireless connection is used.

At this point, computer platform 302 is enabled to communicate with AP/switch 314. On-proxy authenticator proxy 308 is then used to establish a tunneled connection (via AP/switch 314) with cloud authenticator 310 as depicted by a message exchange 324. Various types of tunnels may be used, such as but not limited to TLS or establishing an HTTPS session. Once the cloud backend tunnel is established, cloud authenticator sends corporate network information 326 to on-proxy authenticator proxy 308. The corporate network information may include an SSID or virtual BSSID that will be exposed to supplicant 306 to make it appear that the supplicant is directly connected to a cloud or enterprise backend network.

In message flow diagram 400 of FIG. 4 the messages or frames sent between supplicant 306 and on-platform authenticator proxy 308 are messages/frames that are communicated between the operating system on computer platform 302 and hardware on the computer platform used to implement the on-platform authenticator proxy 308, wherein the communication is via a virtual connection rather than between a supplicant and an 802.1X AP or router/switch. In the case of cloud controller 304, cloud authenticator 310 and cloud authentication server 312 may be implemented on separate physical machines (e.g., separate servers) that are interconnected via a physical link or cloud authenticator 310 and cloud authentication server 312 may comprises software entities that are executed on the same physical machine (e.g., server) that are connected via a virtual channel or the like. In one embodiment, all or a portion of cloud authenticator 310 may be implemented in an Infrastructure Processor Unit (IPU), Data Processor Unit (DPU), or SmartNIC that is installed in the machine used for cloud authentication server 312.

Under FIG. 4 there are three physical or virtual connections and associated protocols:

1. Supplicant 306 to on-platform authenticator proxy 308 (EAPOL)

2. On-platform Authentication proxy 308 to cloud authenticator 310 (tunnel such as TLS)

3. Cloud authenticator 310 to cloud authentication server 312 (RADIUS)

Message flow 400 proceeds as follows. Following obtaining or being provisioned with corporate network information (from above), on-platform authenticator proxy 308 publishes the corporate network information to supplicant 306 (e.g., the operating system on computer platform 302), a depicted by a message 402. An 802.1X authentication process is then initiated by supplicant 306 sending an EAPOL start message 404 to on-platform authenticator proxy 308. In one embodiment, from the perspective of supplicant 306, on-platform authenticator proxy 308 appears to be a WLAN AP (or a LAN router/switch if a wired Ethernet connection is used to couple computer platform 302 to AP/Switch 314. To initiate authentication, on-platform authenticator proxy 308 will periodically transmit EAP-Request Identity frames 406 to a special Layer 2 address (01:80:C2:00:00:03) on the local network segment, which is being emulated by on-platform authenticator proxy 308. Supplicant 306 listens on this address, and on receipt of an EAP-Request Identity frame 406 supplicant 306 responds with an EAP-Response Identity frame 408 containing an identifier for the supplicant such as a User ID.

Following this initial internal message exchange, on-platform authenticator proxy 308 forwards the information in EAP response\identity frame 408 as an EAP response\identity message 410 to cloud authenticator 310. Upon receipt of EAP response\identity message 410, cloud authenticator 310 generates a RADIUS access request message 412 and sends it to cloud authentication server 312 using the RADIUS protocol. In this embodiment, RADIUS is used for back-end 802.1X authentication, while the Diameter protocol may also be used.

Cloud authentication server 312 performs the role of a RADIUS server. The RADIUS server acts as the “security guard” of the network; as users connect to the network, the RADIUS authenticates their identity and authorizes them for network use. The AS/RADIUS server authenticates the user using a valid EAP mode and credentials that were provisioned to the endpoint, which may be certificate in the case of EAP-TLS but could be a SIM card based with EAP-SIM, userID/password with EAP-MS-ChapV2 and so on, where any valid EAP mode may be used. Each time the user connects, the RADIUS server confirms they have the correct credentials and prevents any unapproved users from accessing the network.

A key security mechanism to employ when using RADIUS is server certificate validation. This guarantees that the user (in this case supplicant 306) only connects to the network they intend to by configuring their device to confirm the identity of the RADIUS by checking the server certificate. If the certificate is not the one which the device is looking for, it will not proceed to send a certificate or credentials for authentication.

In diagram 400 RADIUS access request message 412 contains appropriate credentials for supplicant 306 in accordance with the EAP mode that is used. Upon checking and verifying the user's (supplicant's) credential(s) (such as a certificate signature), cloud authentication server 312 sends a RADIUS access challenge message 413 to on-platform authenticator proxy 308 that identifies an EAP authentication method that authentication server 312 proposes to be used for further authentication, which in this example is EAP-TLS. A corresponding EAP-Request\Auth message is then generated by cloud authenticator 310 and sent to supplicant 306 via on-platform authenticator proxy308, as depicted by messages 414 and 416, wherein in message 414 the EAP-Request\Auth message is encapsulated using a secure transport such as TLS. The purpose of this EAP-Request\Auth message is to verify that the supplicant can support the EAP authentication method proposed by the Authentication Server (RADIUS Server), which is, in this embodiment, EAP-TLS.

If supplicant 306 is not configured to support the proposed EAP authentication method (e.g., EAP-TLS), the supplicant can reject the EAP authentication method and request another EAP method by sending an EAP-Response Auth NAK (Negative ACKnowledgement) message which also specifies the EAP authentication method the Supplicant wants to use (not shown). In this example, supplicant 306 is configured to support EAP-TLS, and returns an EAP-Response\Auth message 418 to on-platform authenticator proxy 308 indicating the suggested EAP-TLS authentication method is accepted. On-platform authenticator proxy 308 encapsulates EAP-Response\Auth message 418 in an EAP-Response\Auth message 420 and sends it to cloud authenticator 310. In turn, cloud authenticator 310 generates a corresponding RADIUS access-request message 422 using the RADIUS protocol and sends it cloud authentication server 312. RADIUS access-request message 422 indicates the supplicant agrees to the suggested EAP authentication method (EAP-TLS).

At this point, cloud authenticator 310 and supplicant 306 complete a multi-round authentication message exchange 424 to initiate set up of EAP-TLS. Following authentication message exchange 424, cloud authentication server 312 creates a set of L2 session keys 426 locally to be used for L2 encryption/decryption. Cloud authentication server 312 will then send a RADIUS access-accept message 428 to cloud authenticator 310, which in turn sends an EAP-Success message 430 to supplicant 306. Cloud authentication server 312 may also provide cloud authenticator 310 with L2 session keys 426, which may be sent along with RADIUS access-accept message 428 or in a separate message (not shown).

Upon receipt of EAP-Success message 430, supplicant 306 generates its own set of L2 session keys 432 to be used for L2 encryption/decryption, where L2 session keys 426 and keys 432 are symmetric keys.

At this point, supplicant 306 and cloud authenticator 310 perform a 4-way handshake in accordance with IEEE 802.1X over a tunneled connection 434. The 4-way handshake employs a sequence of four messages that are the same as the 4-way handshake messages that would be exchanged between a supplicant and an Authenticator under conventional IEEE 802.1X.

The supplicant is now enabled to perform a secure data exchange 436 with Cloud authenticator 310 to access data in the secure cloud environment (e.g., enterprise core network) using end-to-end L2 encryption. As discussed above, the L2 frames may be wrapped in a higher layer secure protocol such as TLS in this example. While message flow diagram 400 shows supplicant 306 exchanging data with cloud authenticator 310, a supplicant may also perform an end-to-end L2 encrypted data exchange with other servers in the secure cloud environment when applicable security data is shared by cloud authenticator 310 and/or cloud authentication server 312, such as keys 426.

For example, this is shown in FIG. 1a where cloud authenticator has shared keys 426 with each of edge servers 126. Generally, the keys may be shared with zero or more edge servers. Also, the cloud authenticator may be implemented in an edge server, as discussed above. As further shown in FIG. 1a, platform 102 is now able to access servers in the core of secure cloud environment 104 (e.g., one or more of other servers 128) using an end-to-end L2 encrypted data with one of edge servers 126.

Computer Platform/System Architectures

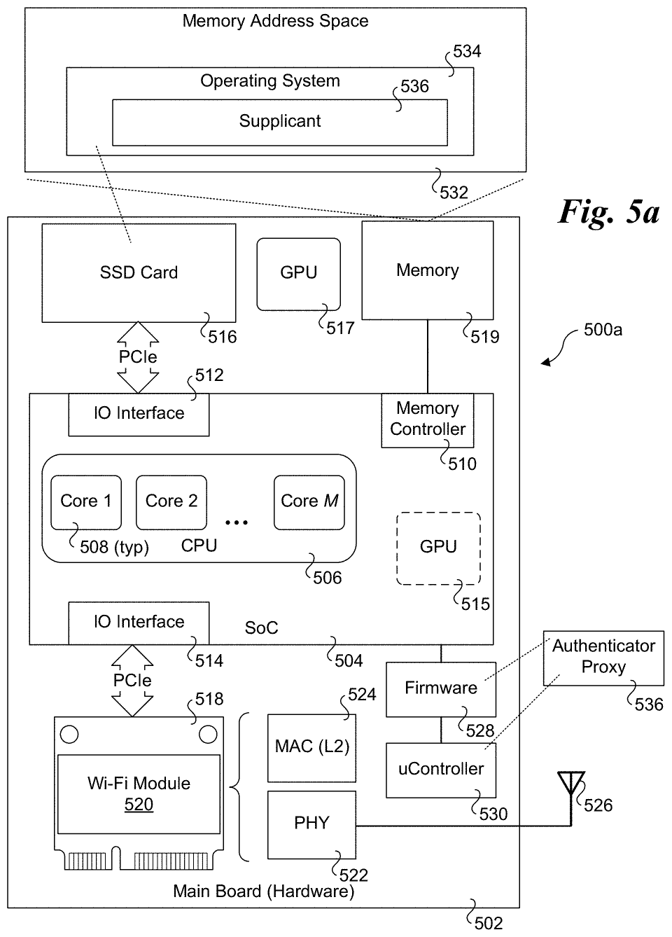

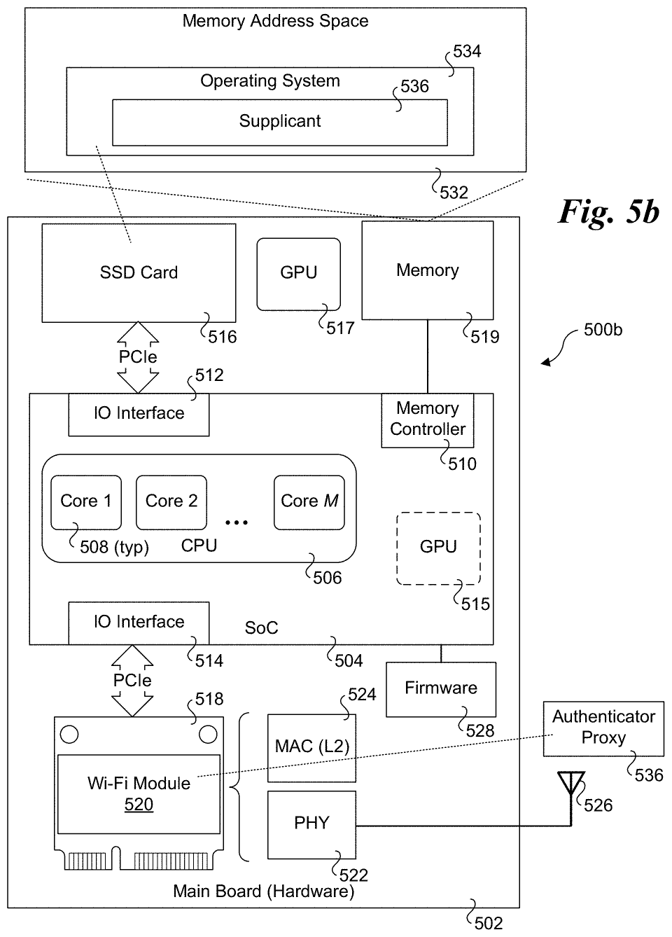

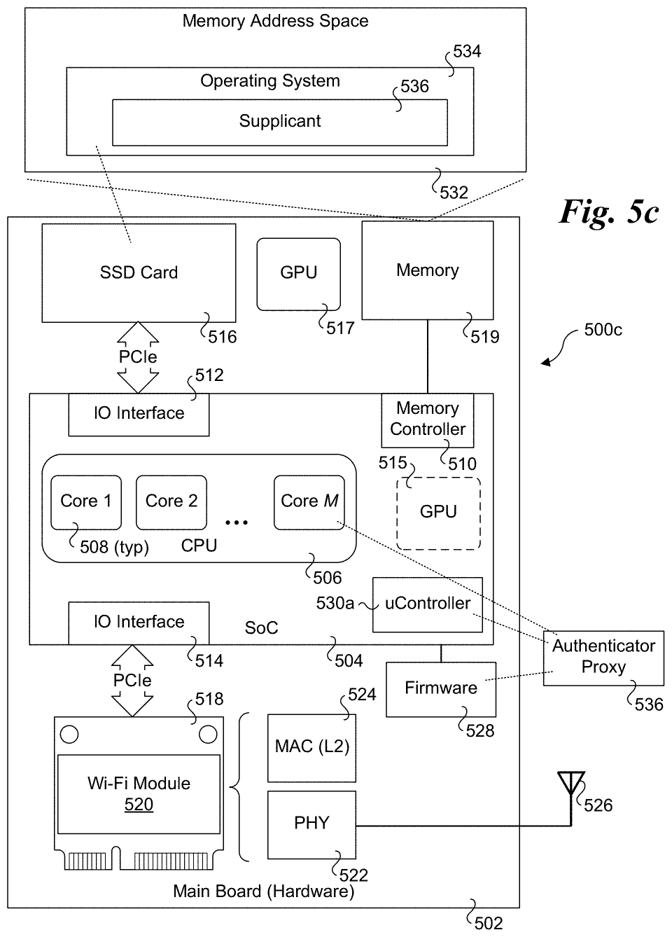

Non-limiting examples of computer platform or system architectures are shown for a laptop or notebook computer are shown in FIGS. 5a, 5b, and 5c. Under platform architecture 500a, the computer platform/system includes hardware 502 comprising a main board to which a processor System on Chip (SoC) 504 is mounted (e.g., via flip-chip bonding, socketed, or any other mounting technique. Processor SoC 504 includes a central processing unit (CPU) 506 having M processor cores 508, where M is an integer such as 4, 6, 8, 10, 12 . . . etc. In this example, the processor cores are depicted as to appear the same for simplicity. An SoC may include more than one type of processor core, such as a combination of higher performance cores that consume relatively more power and lower performance cores that consume relatively less power. Generally, CPU 506 may employ various types of architectures including but not limited to x86 architectures and ARM®-based cores, RISC, etc., including a mixture of core architectures. Processor SoC 504 further includes a memory controller 510 and a pair of Input-Output (IO) interfaces. In addition to the components shown, processor SoC 504 would generally include a cache hierarchy and various levels of interconnects that are not shown for simplicity and to reduce clutter. For example, each processor core 508 may include a Level 1 (L1) and Level 2 (L2) cache, while the SoC may include a Last Level Cache (LLC) that is shared among the processor cores.

In some embodiments processor SoC 504 includes a Graphics Processor Unit (GPU) 515, while in other embodiments a GPU 517 that is external to the processor SoC is employed, such as deployed in a graphics card or the like. A processor SoC may also include a myriad of other component, such as power-related components, and management components that are also not shown.

Hardware 502 further includes a solid-state disk (SSD) card 516, a wireless card 518, and memory 519. SSD card employs a type of non-volatile memory, such as a type of Flash memory, NVRAM, etc. In one embodiment, SSD card is a mini-PCIe (Peripheral Component Interconnect Express) card and is connected via a PCIe interconnect/bus to IO interface 512. Other interconnect structures and protocols may also be used, with the use of PCIe in the figures herein being merely exemplary and non-limiting.

Wireless card 520 is depicted as a mini-PCIe card that includes a Wi-Fi module 520 that includes suitable circuitry and logic for implementing one or more IEEE 802.11 standards. The circuitry and logic include circuitry for implement a Physical Layer (PHY) 522 and a Media Access Control Layer (MAC) 524. The MAC layer is Layer 2 for both Wi-Fi and Ethernet-based network interfaces. PHY 522 is connected to an antenna 526. Wi-Fi module 520 may also provide other types of wireless support, such as Bluetooth®. In one embodiment, MAC 524 is configured to perform L2 encryption and decryption operations.

Hardware 502 also includes one or more firmware storage devices 528 and a microcontroller 530. Generally, microcontroller 530 (and the use of the term “microcontroller” herein) is representative of a processing element comprising a hardware component configured to execute instructions to effect one or more functions. Under platform architecture 500a, an authenticator proxy 536 is implemented via execution of firmware instructions on microcontroller 530, where the firmware instructions are stored in firmware storage device 528, which may be the same firmware storage device for the compute platform or a separate device. As another option, the firmware instructions may be stored on microcontroller 530. Generally, microcontroller 530 may be a stand-alone chip or integrated on another chip installed on the main board, such as a manageability engine, for example.

Memory 519 is physically implemented as one or more DRAM (Dynamic Random Access Memory) devices or modules, such as DRAM DIMMS (Dual Inline Memory Modules). Memory 519 and memory controller 510 comprise a memory subsystem that may be compatible with various memory technologies, such as DDR4 (Double Data Rate version 4, initial specification published in September 2012 by JEDEC (Joint Electronic Device Engineering Council). DDR4E (DDR version 4), LPDDR3 (Low Power DDR version 3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5), LPDDR5, HBM2E, HBM3, and HBM-PIM, or others or combinations of memory technologies, and technologies based on derivatives or extensions of such specifications. The JEDEC standards are available at www.jedec.org.

The physical memory on the memory devices/modules are mapped into a memory address space 532 into which software is loaded for execution. This includes an operating system 534 including a supplicant 536. Generally, the software loaded into memory address space 532 may be stored on SSD card 516 or loaded via a network once the platform has booted. The computer platform/system will also load system firmware into a protected region in memory address space 532 to facilitate booting the platform and also to be used for run-time operations.

A power source (not depicted) provides power to the components of hardware 502. The power source generally interfaces to one or multiple power supplies in the computer to provide power to the components of the computer platform. In one example, the power supply includes an AC to DC (alternating current to direct current) adapter to plug into a wall outlet. In one example, the power source can include an internal battery in combination with an, alternating current supply.

Under platform architecture 500b in FIG. 5b, the functionality for authenticator proxy 536 is implemented using embedded logic in wireless card 518. Non-limiting examples of embedded logic include fixed logic (e.g., an Application Specific Integrated Circuit (ASIC), programmable logic (e.g., a Field Programmable Gate Array (FPGA)) are a combination of fixed and programmable logic. It is noted that an FPGA may be pre-programmed. As another option, wireless card 518 may include a processing element on which instructions are executed to implement the functionality of authenticator proxy 536.

Under platform architecture 500c in FIG. 5c, the functionality for authenticator proxy 536 is implemented via execution of firmware instructions on a microcontroller 530a that is integrated on processor SoC 504. As an option, firmware instructions for implementing the functionality of authenticator proxy 536 may be executed on one or processor cores 508.

Generally, other computer platforms and systems such as desktop computers and workstations, may employ similar architectures to those shown in FIGS. 5a, 5b, and 5c. Some difference include a GPU may be installed on the main board or deployed in an expansion card or the like, such as but not limited to a PCIe expansion card. A desktop computer may also include a networking card or networking chip to provide a wired Ethernet connect to a local AP or switch. For example, non-limiting examples include a Network Interface Controller (NIC) chip or expansion card with a NIC. Generally, a desktop computer or workstation may or may not include provisions for wireless communication.

The platforms shown in FIGS. 5a, 5b, and 5c are generally representative of any type of device that can establish a connection a wireless connection with an AP or a wired connection with a switch. Such devices include but are not limited to laptops/notebooks, netbooks, mobile devices (mobile phones and tablets), Internet of Things (IOT) devices, and wearable devices.

Similar to the examples above, the functionality for the authenticator proxy may be implemented using various forms of hardware in a desktop computer or workstation. This include but are not limited to a separate microcontroller, embedded logic (e.g., on a NIC or SmartNIC), or execution of firmware on a core, microcontroller, or other processing element on a processor SoC.

Generally, various types of compute or server platforms may be used for the servers described an illustrated herein using known configurations. In some embodiments the servers are implemented in one or more racks in a data center or server farm. Such servers may have various physical formats including blade servers, server modules, 1U, 2U, and 4U servers, etc. The servers may be deployed in chassis, drawers, sleds, trays, or cabinets, as well as standalone “boxes”. The servers will include compute and networking facilities for executing software to effect the server functions describe and illustrated herein and for connecting to one or more networks.

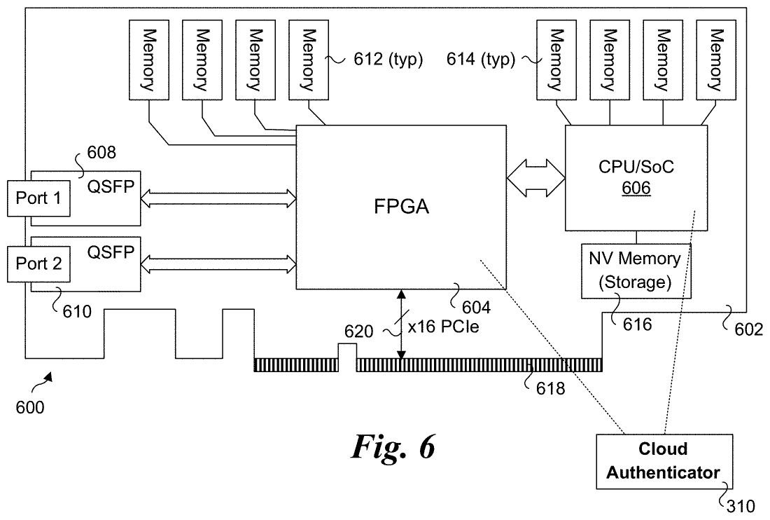

As described above, the cloud authenticator and cloud authentication server may be implemented on separate machines (e.g., separate servers) or may comprise software components implemented on the same machine. Also, as mentioned above, the cloud authenticator may be implemented using an IPU or DPU or a SmartNIC. As illustrated in FIG. 6 an IPU may comprises an expansion card or the like that is installed in a computer platform or system, such as a server. Generally, a DPU may employ similar components and be deployed in an expansion card or the like or as a DPU chip installed in a server.

FIG. 6 shows one embodiment of IPU 600 comprising a PCIe card including a circuit board 602 having a PCIe edge connector to which various integrated circuit (IC) chips and modules are mounted. The IC chips and modules include an FPGA 604, a CPU/SoC 606, a pair of QSFP (Quad Small Form factor Pluggable) modules 608 and 610, memory (e.g., DDR4 or DDR5 DRAM) chips 612 and 614, and non-volatile memory 616 used for local persistent storage. FPGA 604 includes a PCIe interface (not shown) connected to a PCIe edge connector 618 via a PCIe interconnect 620 which in this example is 16 lanes. FPGA 604 may include logic that is pre-programmed (e.g., by a manufacturing) and/or logic that is programmed in the field (e.g., using FPGA bitstreams and the like). For example, logic in FPGA 604 may be programmed by a host CPU for a platform in which IPU 600 is installed. IPU 600 may also include other interfaces (not shown) that may be used to program logic in FPGA 604. In place of QSFP modules 608, wired network modules may be provided, such as wired Ethernet modules (not shown).

CPU/SoC 606 employs a System on Chip including multiple processor cores. Various CPU/processor architectures may be used, including but not limited to x86, ARM®, and RISC architectures. In one non-limiting example, CPU/SoC 606 comprises an Intel® Xeon®-D processor. Software executed on the processor cores may be loaded into memory 614, either from a storage device (not shown), for a host, or received over a network coupled to QSFP module 608 or QSFP module 610.

As further shown in FIG. 6, the functionality of cloud authenticator 310 may be implemented via execution of instructions on CPU/SoC 606, via programmed logic in FPGA 604, or a combination of the two. Generally, the instructions may be stored in NV memory 616 or loaded from a network.

Embodiments of the solutions provided herein provide many advantages over existing approaches. These include but are not limited to:

Flexibility/Scalability/Cost—the solution is available wherever the platform has connectivity and therefore is not dependent on any special hardware to be available.

Simplicity—the solution does not alter the OS network stack with virtual interfaces and does not require complex interactions between agents and other OS entities that creates challenge with today's VPN setup.

Performance—all the encryption is handled by the platform existing layer 2 (MAC) encryption engines used in conventional Wi-Fi or Ethernet encryption and does not take resources from the OS. Furthermore, since the whole L2 operation is offloaded it can be further optimized to run on platform accelerator vs. CPU improving latency and power.

Cost Savings—This solution replaces adding dedicated hardware to each employee home (estimated today at around $500 per employee) with a platform-based solution that works anywhere and provides the same security and performance.

Security—Layer 2 encryption is more standard and while it, too, has been compromised in the past such events are rare, which cannot be said of Layer 3 encryption solutions that are often compromised.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by processor, embedded processor, microcontroller or other processing element or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
implementing an Institute of Electrical and Electronics Engineers (IEEE) 802.1X authenticator proxy in a computer platform communicatively coupled to a switch or an access point (AP) in a local area network (LAN) or a wireless LAN (WLAN);
employing the IEEE 802.1X authenticator proxy to proxy Extensible Authentication Protocol (EAP) messages communicated between a supplicant on the computer platform and an authentication server in a secure cloud environment accessed via the switch or AP to establish an encrypted Layer 2 (L2) end-to-end tunnel between the computer platform and one or more servers in the secure cloud environment using an IEEE 802.1X authentication process.

2. The method of claim 1, wherein a cloud authenticator is implemented in the secure cloud environment, and wherein the IEEE 802.1X authenticator proxy and the cloud authenticator are configured to collectively operate as an IEEE 802.1X authenticator.

3. The method of claim 1, wherein, from the perspective of the authentication server, the authentication server is communicating with an IEEE 802.1X authenticator.

4. The method of claim 1, wherein the computer platform is running an operating system, further comprising exposing the secure cloud environment to the operating system as a virtual Wireless Local Area Network (WLAN).

5. The method of claim 1, wherein the AP is deployed in a WLAN that is accessible to the public.

6. The method of claim 1, wherein the secure cloud environment comprises a secure backend overlay network, and the LAN or WLAN comprises an underlay network.

7. The method of claim 6, wherein the computer platform is running an operating system, further comprising exposing the overlay network as an enterprise SSID (Service Set Identifier).

8. The method of claim 1, wherein the secure cloud environment employs a (Secure Access Service Edge) SASE architecture.

9. The method of claim 1, wherein the 802.1X authenticator proxy is implemented using embedded logic in hardware on the computer platform.

10. The method of claim 9, wherein the embedded logic comprises one or more of firmware executing on an embedded processor, logic programmed into a programmable logic device, or one or more Application Specific Integrated Circuits (ASICs) containing fixed logic.

11. A computer system comprising:
hardware, including a processor, memory, and a wireless network interface configured to connect to an access point (AP) compatible with an Institute of Electrical and Electronics Engineers (IEEE) 802.11-based standard; and
software, configured to be executed on the processor, including an operating system,
wherein the hardware is configured to operate as an IEEE 802.1X authenticator proxy in connection with performing an IEEE 802.1X authentication process.

12. The computer system of claim 11, wherein the hardware is further configured to:
enable the computer system to connect to an IEEE 802.11-based AP via the wireless network interface; and
expose a virtual network to the operating system as a virtual wireless network BSSID (Basic Service Set Identifier).

13. The computer system of claim 11, wherein the IEEE 802.1X authentication process comprises:
connecting to an AP compatible with an Institute of Electrical and Electronics Engineers (IEEE) 802.11-based standard via the wireless network interface; and
sending Extensible Authentication Protocol (EAP) messages from the computer platform to and receiving EAP messages from an authentication server in a secure cloud environment accessed via the AP to establish an encrypted Layer 2 (L2) end-to-end tunnel.

14. The computer system of claim 13, wherein the connection to the IEEE 802.11-based AP forms an underlay transport and the connection to the secure cloud environment comprises an overlay network connection, and wherein the hardware is further configured to expose a secure, virtual enterprise network connection to the operating system over the underlay transport

15. The computer system of claim 11, wherein the computer system comprises a laptop computer, a notebook computer, or a desktop computer.

16. An apparatus configured to be implemented in a computer platform and comprising embedded logic to enable the computer platform to operate as an Institute of Electrical and Electronics Engineers (IEEE) 802.1X authenticator proxy, wherein the IEEE 802.1X authenticator proxy is enabled to proxy Extensible Authentication Protocol (EAP) messages communicated between a supplicant on the computer platform and an authentication server in a secure cloud environment to establish an encrypted Layer 2 (L2) end-to-end tunnel between the computer platform and one or more servers in the secure cloud environment using an IEEE 802.1X authentication process.

17. The apparatus of claim 16, wherein the apparatus comprises a network interface chip or a wireless network interface chip.

18. The apparatus of claim 16, wherein the apparatus comprises a processing element and the embedded logic comprises firmware that is executed on the processing element.

19. The apparatus of claim 16, wherein a cloud authenticator is implemented in the secure cloud environment, wherein the IEEE 802.1X authenticator proxy and the cloud authenticator are configured to collectively operate as an IEEE 802.1X authenticator and the IEEE 802.1X authenticator is used to proxy EAP messages between the supplicant and the cloud authenticator.

20. The apparatus of claim 16, wherein the computer platform is configured to connected to an access point (AP) having a Service Set Identifier (SSID), and wherein the IEEE 802.1X authenticator proxy is configured to expose the secure cloud environment to an operating system on the computer platform as a virtual Wireless Local Area Network (WLAN).

21. A server, configured to be implemented in a secure cloud environment including an Institute of Electrical and Electronics Engineers (IEEE) 802.1X authentication server (AS), wherein the server is configured as a cloud authenticator that performs server-side operations in cooperation with an authenticator proxy in a client device connected to the secure cloud environment to facilitate establishment of an encrypted Layer 2 (L2) end-to-end tunnel between the client device and one or more servers in the secure cloud environment using an IEEE 802.1X authentication process.

22. The server of claim 21, wherein the server comprises an edge server in the secure cloud environment.

23. The server of claim 21, wherein the server is configured to:
proxy a plurality of messages that are exchanged between the client device and the AS, wherein messages received for the client device using a first protocol are forwarded to the AS using a RADIUS or Diameter protocol, and received from the AS using the RADIUS or Diameter protocol are forwarded to the client device using the first protocol.

24. The server of claim 23, wherein the first protocol comprises an Extensible Authentication Protocol (EAP).

25. The server of claim 21, configured to:
establish a secured tunneled connection with the client device; and
perform a 4-way 802.1X handshake with the client device using the secure tunneled connection.
